(19) United States
(12) Patent Application Publication
(10) Pub. No.: US 2019/0228322 A1
(43) Pub. Date: Jul. 25, 2019

(54) VEHICLE REPAIR GUIDANCE SYSTEM

(71) Applicant: NOREGON SYSTEMS, INC., Greensboro, NC (US)

(72) Inventors: Jennifer WENNER, High Point, NC (US); Michael LIS, Kernersville, NC (US); Brandon GALE, Walkertown, NC (US); Lee LACKEY, Clemmons, NC (US)

(73) Assignee: NOREGON SYSTEMS, INC., Greensboro, NC (US)

(21) Appl. No.: 16/041,133

(22) Filed: Jul. 20, 2018

Related U.S. Application Data
(60) Provisional application No. 62/621,772, filed on Jan. 25, 2018.

(51) Int. Cl. G06N 5/04; G07C 5/08; G07C 5/00; G06N 7/00

(52) U.S. Cl. CPC G06N 5/04; G07C 5/0816; G06N 7/005; G07C 5/008; G07C 5/006

(57) ABSTRACT

Systems and methods for creating fault groups of related vehicle component faults and recommending a solution for resolving detected faults are provided. In one implementation, a method includes a step of obtaining historical data related to a plurality of vehicle component faults detected from a plurality of vehicles. The method also includes the step of statistically associating the vehicle component faults to categorize the vehicle component faults into a plurality of fault groups. The vehicle component faults that are categorized in the same group have a higher probability of occurring together than vehicle component faults that are categorized in different groups.

### BACKGROUND

Many electrical systems in a vehicle are controlled by electronic control units (ECUs). The ECUs may include sensors and actuators, the sensors being used for sensing various aspects of the vehicle and the actuators being used for controlling the operations of different vehicle components. From the characteristics sensed by the ECUs, fault testing of vehicle components can be performed by an on-board diagnostics (OBD) system and any faults detected can be communicated to an external device via an OBD connector.

Over the past several years, heavy duty trucks have become increasingly complex in terms of the number of ECUs that are configured to control the engine, transmission, emissions, brakes, lights, safety components, and other components of the vehicle. Regarding emissions, for example, a proliferation of new ECUs has stemmed from regulatory changes made in 2004, 2007, 2010, and 2014.

On modern trucks, each of these ECUs is capable of sensing thousands of diagnostic conditions, which are used by trained technicians to detect, diagnose, and correct issues associated with the truck. Accessing these faults, however, presents a challenge because the driver of the vehicle is normally only provided with vague indications of these faults, such as a “check engine” light.

Fortunately, there are several commercially available applications and devices that can read fault data from the ECUs, extract them from the ECUs, and transmit them to a remote location for analysis. Some of these applications are intended for technicians that utilize this information to resolve faults occurring in the vehicle. These applications typically take the form of a diagnostic tool and assume a detailed level of understanding of fault codes and what they mean.

Other systems are intended for truck drivers, fleet dispatchers, service managers, fleet managers, and other non-technician people who may not be skilled in the trade of diagnosing and repairing vehicles. Even for these users, fault codes in a human readable form do not mean very much because of their lack of training and knowledge regarding the vehicle's operability. Thus, these non-technician users, in the absence of a trained vehicle technician, may not treat the fault codes appropriately. For example, they may ignore the fault codes and assume the vehicle does not need servicing. On the other hand, they may treat fault codes more strictly than necessary and assume that a drivable vehicle should not be driven.

While it is possible to troubleshoot a vehicle in order to resolve its faults, the process of fault resolution may be tedious and time consuming because of the sheer amount of fault related information that may have to be studied and analyzed prior to beginning the troubleshooting process. As such, a method of analyzing the extracted fault data and streamlining the fault data in order to provide a problem resolution recommendation is envisioned.

### SUMMARY

The present application relates to systems and methods for creating a plurality of fault groups for categorizing vehicle component faults that are related to each other. The present application also relates to systems and methods for determining a troubleshooting order for providing guidance with respect to a sequence of troubleshooting steps that may be taken to repair a vehicle having a number of detected faults categorized in the same fault group. In addition, the present application relates to systems and methods for detecting faults in a vehicle and utilizing the fault groups and troubleshooting steps to recommend a plan for resolving the faults.

According to one embodiment, a method is provided for creating fault groups. The method may comprise steps of obtaining historical data related to a plurality of vehicle component faults that have been detected in a plurality of vehicles having a plurality of makes and models and then storing the historical data in a database. The method may also include statistically associating the vehicle component faults to categorize the vehicle component faults into a plurality of fault groups, such that the vehicle component faults that are categorized in the same fault group have a higher probability of occurring together than vehicle component faults that are categorized in different fault groups. Furthermore, the method may include the steps of identifying and eliminating fault groups that are mathematical subsets of larger fault groups and identifying and eliminating vehicle component faults that appear in multiple fault groups. The method may also include creating a troubleshooting order for each fault group, wherein each troubleshooting order includes a sequence of troubleshooting steps for resolving the vehicle component faults in the respective fault group. The fault groups and corresponding troubleshooting order may also be stored in the database.

According to another embodiment, a method may comprise the step of obtaining historical data related to a plurality of vehicle component faults detected from a plurality of vehicles. The method may also comprise the step of statistically associating the vehicle component faults to categorize the vehicle component faults into a plurality of fault groups such that the vehicle component faults that are categorized in the same group have a higher probability of occurring together than vehicle component faults that are categorized in different groups.

In yet another embodiment, a system is provided. The system may include a diagnostic apparatus arranged in electrical communication with a port of a vehicle to be serviced. The diagnostic apparatus may be configured to extract fault data via the port, wherein the fault data may include a list of vehicle component faults detected by a plurality of electronic control units (ECUs) integrated in the vehicle. The system may further comprise a central monitoring station arranged in electrical communication with the diagnostic apparatus to obtain the list of vehicle component faults. The central monitoring station may be configured to identify one or more pre-defined fault groups in which the list of vehicle component faults can be categorized. Also, the central monitoring station may further be configured to create a problem resolution recommendation based on the list of vehicle component faults and a pre-established troubleshooting order for each of the pre-defined fault groups.

### BRIEF DESCRIPTION OF THE DRAWINGS

For clarity, the drawings in this document are not necessarily drawn to scale, and are provided to illuminate the concepts of the subject matter, but not to limit the features discussed in the application.

FIG. 1 is a diagram illustrating a diagnostic system for diagnosing faults of a vehicle, according to one embodiment.

FIG. 2 is a diagram illustrating exemplary diagnostic devices that can be used in the diagnostic system of FIG. 1, according to one embodiment.

FIG. 3 is a diagram illustrating exemplary cables and connectors that can be used in the diagnostic system of FIG. 1, according to one embodiment.

FIG. 4 is a block diagram illustrating the central monitoring station shown in FIG. 1, according to one embodiment.

FIG. 5 is a diagram illustrating a data stream of faults detected by the diagnostic system of FIG. 1, according to one embodiment.

FIGS. 6A-6C are diagrams illustrating charts for defining a troubleshooting order for each of a number of fault groups, according to one embodiment.

FIG. 7 is a flow diagram illustrating a method of creating fault groups and corresponding troubleshooting orders, according to one embodiment.

FIG. 8 is a flow diagram illustrating a method of operating the diagnostic system of FIG. 1 based on detected faults, according to one embodiment.

FIG. 9 is a flow diagram illustrating a method of determining a problem resolution recommendation, according to one embodiment.

FIG. 10 is a graphical user interface for displaying fault data obtained by the diagnostic system of FIG. 1, according to one embodiment.

### DETAILED DESCRIPTION

The present application relates to vehicle repair guidance systems and methods based on fault association. The systems and methods may provide both trained technicians and untrained users with a problem resolution recommendation after analyzing fault data that is extracted from a vehicle and analyzed in light of pre-established fault categorization.

The systems and methods for providing vehicle repair guidance are based on fault association in which fault data extracted from the vehicle can be compared with pre-analyzed and pre-identified fault groups in order to identify overlapping fault data patterns. Upon the identification of an overlapping fault data pattern between the extracted data and the fault groups, the embodiments of the present disclosure can select faults from within a fault group comprising faults with a fault pattern that overlaps with the fault pattern from the extracted fault data and identify a root cause fault. The root cause fault can then be identified as a starting point of the troubleshooting process. The root cause identification and a troubleshooting order may be used as the problem resolution recommendation for a particular system of the vehicle.

The creation of the pre-analyzed and pre-identified fault groups may involve processing and categorizing approximately two million logs of information comprising over 17 million instances of faults. Analyzing such a significant amount of data allows for the identification of specialized associations between fault instances, which increases the likelihood of resolving one or more fault occurrences in a vehicle within an expedited time frame.

Methods for providing guidance regarding how to repair a vehicle are also provided. The vehicle repair guidance methods may be implemented on a variety of vehicles. However, for the purposes of ease of description and illustration, the vehicle described herein may be a heavy duty vehicle, such as a tractor-trailer vehicle, an 18 wheel semi-automatic vehicle, or the like.

The systems and methods of the present disclosure are an improvement over conventional systems, which might merely present a list of faults detected in a vehicle. With the grouping of faults and the recommendation of repairing faults based on a predetermined troubleshooting sequence, the systems and methods of the present disclosure are able to reduce repair time by prioritizing the faults. When a first fault in a sequence of faults is resolved based on a predetermined plan, other related faults may be resolved as well.

Without a predetermined troubleshooting plan, a mechanic may simply attempt to resolve the faults in any particular order, which may be more time consuming and more costly. For example, repairs may be made for a vehicle component unnecessarily, such that those repairs do not resolve the bigger issues. Therefore, by using the historical data to determine related faults and a troubleshooting order for resolving the faults, the resolution of faults in an intelligent order may subsequently resolve lower level faults, resulting in quicker repair times and also possibly resulting in fewer components being replaced. Ultimately, the systems and methods of the present disclosure may help to reduce costs by minimizing unneeded repairs, the unneeded repairs resulting in extra costs of the replacement parts themselves plus the labor costs.

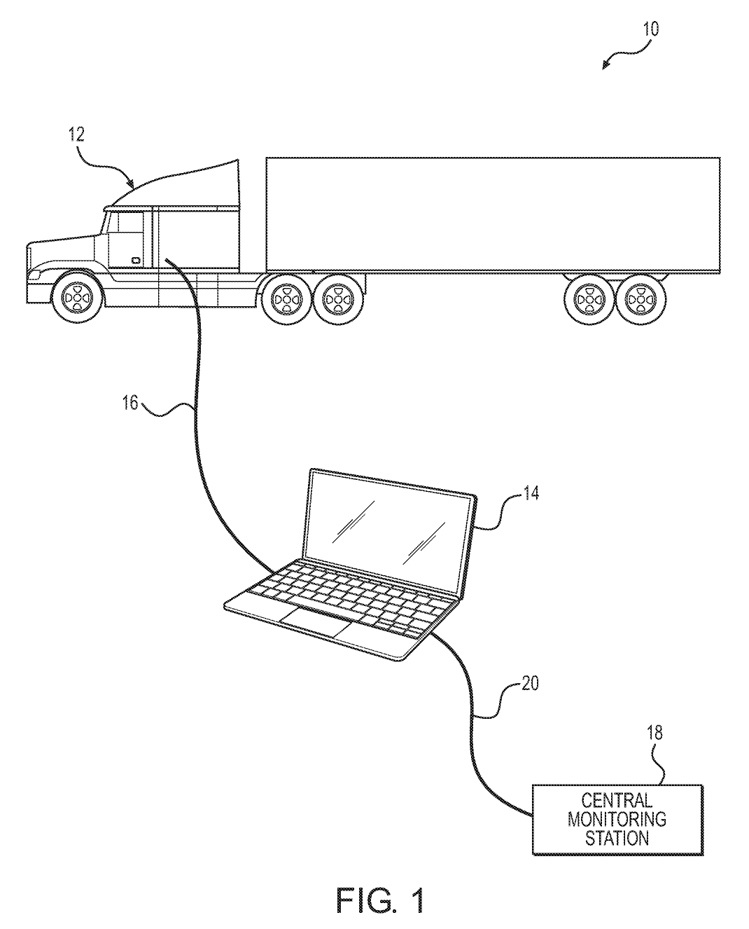

FIG. 1 illustrates a vehicle repair guidance system 10 for diagnosing faults in a vehicle 12 and providing guidance on how to repair the vehicle 12 when faults are detected. Fault information is communicated from the vehicle 12 to a diagnostic device 14 via a cable 16 and the diagnostic device 14 is configured to communicate the fault information to a central monitoring station 18 via a communication path 20. The central monitoring station 18 may be configured with access to a network and may be adapted to monitor fault data from a plurality of diagnostic devices 14 located remote from each other.

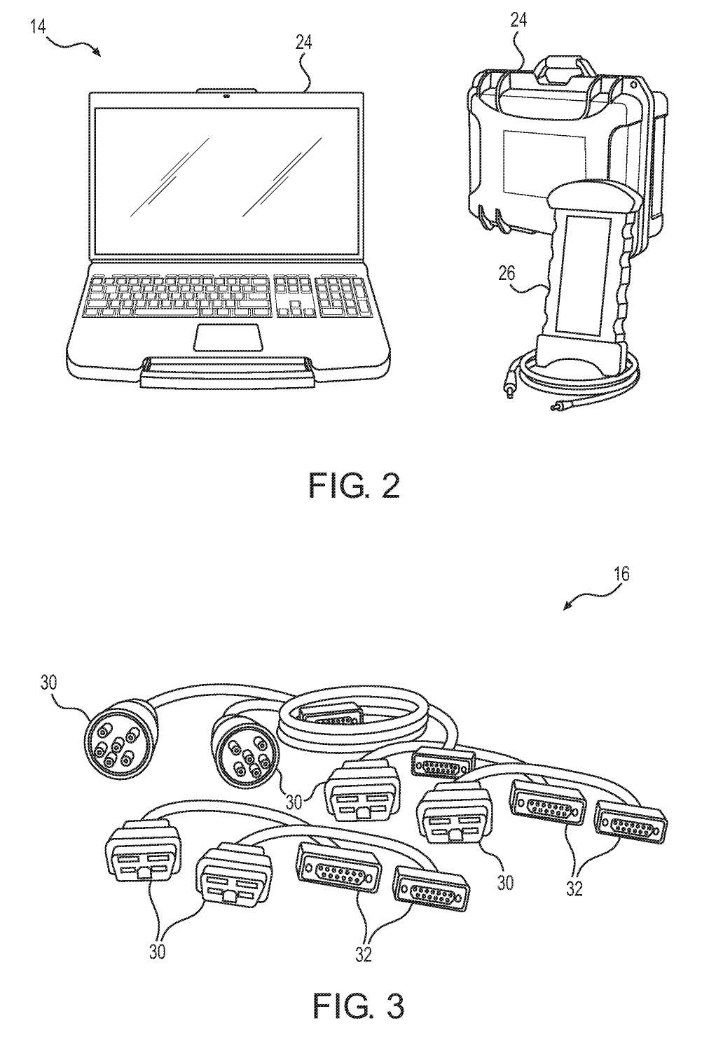

FIG. 2 illustrates embodiments of the diagnostic device 14 shown in FIG. 1. The diagnostic device 14 may include a laptop computer 24 and/or a handheld diagnostic device 26. The laptop computer 24 may be integrated into a storage case, which may include a handle for easily carrying the laptop computer 24.

FIG. 3 illustrates various embodiments of the cable 16 shown in FIG. 1 for communicating fault data from the vehicle 12 to the diagnostic device 14. Each cable 16 may include a first connector 30 configured for connection with the vehicle 12 being diagnosed and a second connector 32 configured for connection with the diagnostic device 14.

The vehicle repair guidance system 10 shown in FIGS. 1-3 is a diagnostic apparatus for diagnosing faults of the vehicle 12 and then presenting the faults in a pre-arranged manner. The vehicle repair guidance system 10 may be configured to read data from any vehicle that is equipped with a heavy duty vehicle data bus connector corresponding to the first connector 30 of the cables 16 shown in FIG. 3. The diagnostic device 14 is configured to access the status of the operating components of the vehicle 12.

The diagnostic device 14 may be configured as a personal computer (“PC”), laptop computer, or other similar device containing a microcontroller or micro-processor. The diagnostic device 14 may include sufficient memory and software to perform the tasks needed for diagnosing faults. In some embodiments, the diagnostic device 14 may be configured to perform the fault diagnosis by itself. In other embodiments, the information regarding faults may be forwarded to the central monitoring station 18 for diagnosing the faults and determining the proper course of action to resolve the faults.

The diagnostic device 14 may be equipped with cables 16 for communicating with a user (e.g., vehicle owner, vehicle driver, third party, etc.). The diagnostic device 14 or laptop computer 24 may include a display device for displaying fault data to the user, including, but not necessarily limited to, a touch screen, standard LCD, Plasma, CRT, LED display, LEDs, sound alerts or recorded voice instructions. The diagnostic device 14 may be integrated with a network interface including, but not limited to, a wired or wireless LAN, WAN, CAN, or LIN based network utilizing Ethernet, ISDN, Zigbee, IEEE 802.11, Cable Broadband, or DSL.

The laptop computer 24 shown in FIG. 2 may further include an adapter or cable 16 that enables the laptop computer 24 to interface with the vehicle 12. The interfacing may include fault data extraction, vehicle parameter adjustments, and reprogramming of vehicle information. The cable 16 may include an adapter including, but not limited to, a DLA+2.0 adapter kit.

The connectors 30, 32 of the cables 16 may be configured as interfaces that connect the laptop computer 24 to the cable 16 and the cable 16 to the vehicle 12. The cable 16 that connects the vehicle 12 to the adapter could be a Type-2 vehicle cable with one or more connection heads including, but not limited to an SAE J 1939-13 6 pin Deutsch connector for vehicles built prior to 2007, an SAE 11939-13 9 pin Deutsch connector for vehicles built from 2007 to the present, and/or an SAE J 1962 connector for 2013 and newer trucks. A Type-B OBDII cable may also be used for vehicles manufactured by Ford, GM, Sprinter, Mack, and Volvo. The Type-2 vehicle cable 16 is designed to reach from the adapter to a location on the vehicle 12 where the cable 16 may be attached. This location could be, but is not limited to, the driver's side of the vehicle.

The cable 16 may be flexible, so it can be routed over and around many different types of obstacles. The second connector 32 of the cables 16 is adapted to connect with a suitable connector on the diagnostic device 14 and may be, but is not limited to, a USB connector, 15-pin connector, or other suitable connector.

While a physical connection in the form of a Type 2 cable may be used to extract fault data from the vehicle 12, a functioning telematics device may be installed on the vehicle 12 in place of a physical connection. After the fault data is extracted from the vehicle 12 and accessed on the laptop 24, it may be sent to a central monitoring station 18 for analysis.

As shown in FIG. 1, the central monitoring station 18 receives vehicle data from the diagnostic device 14 and analyzes the received vehicle fault data in order to identify a root cause fault. The purpose and significance of the root cause fault identification will be discussed in detail below.

In some embodiments, the cable 16 may be replaced with wireless communication equipment for enabling communication between the vehicle 12 and the diagnostic device 14. The central monitoring station 18 may also communicate with the diagnostic apparatus through either a wired connection or wireless antenna that can be connected to a wireless point.

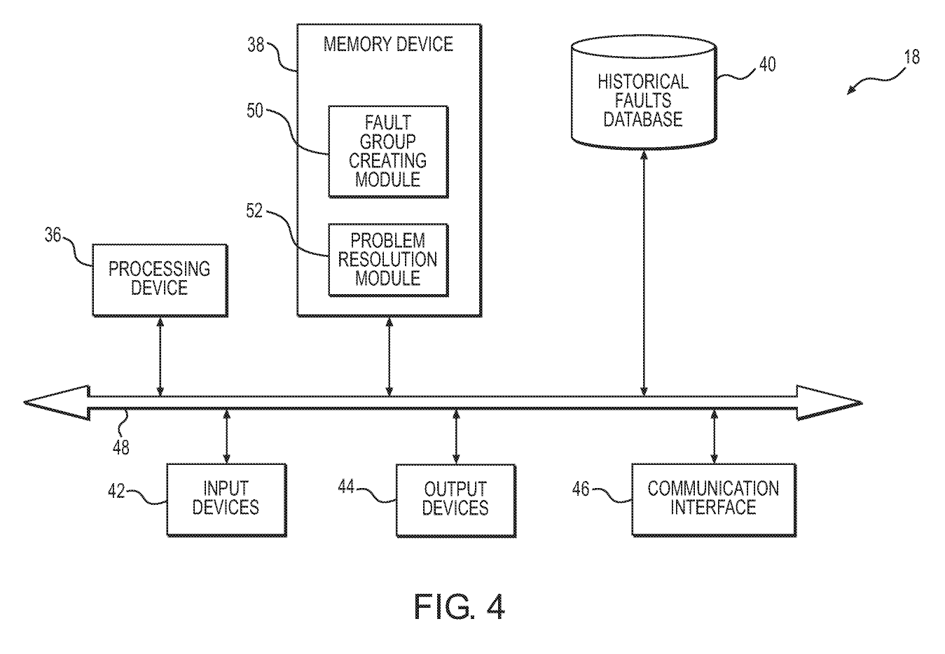

FIG. 4 illustrates an embodiment of the central monitoring station 18. In some embodiments, parts or all of the components shown in FIG. 4 may be integrated in either or both of the diagnostic device 14 and central monitoring station 18. However, for the purpose of simplification of the present description, the components of FIG. 4 are described below as being part of the central monitoring station 18.

The central monitoring station 18, according to the embodiment of FIG. 4, includes a processing device 36, a memory device 38, a historical faults database 40, one or more input devices 42, one or more output devices 44, and a communication interface 46. In order to perform many of the functions described in the present disclosure, the memory device 38 may include software and/or firmware for detecting and analyzing faults and also determining how to resolve the faults. For example, the memory device 38 may include a fault group creating module 50, a problem resolution module 52, among other software or firmware modules.

The modules 50, 52 may be implemented in software and/or firmware according to some embodiments. However, according to alternative embodiments, the modules 50, 52 may be implemented, at least partially, as hardware in the processing device 36. For instance, the processing device 36 may comprise logic elements configured to perform various functions of creating groups of faults that are related to each other and an order that the faults can be resolved to minimize unneeded repairs when multiple faults within a group are detected. The order of fault resolution can then be used, upon diagnosing the various faults, to repair the vehicle 12 in a logical manner with minimal repairs.

The processing device 36 is configured to utilize the fault group creating module 50 and problem resolution module 52 to process fault data. The historical faults database 40 may include faults that have been detected for a plurality of vehicles. Also, as new fault data is acquired, this new data can be stored in the historical faults database 40. When new fault data is obtained and stored in the historical faults database 40, the probability of accurately arriving at a workable fault resolution strategy increases as the associations of faults are more firmly established through repeated tests by numerous technicians on numerous vehicles.

The input devices 42 may include user interface devices, such as keyboards, keypads, touch pads, computer mice, microphones, and other devices for enabling a user to input user selections into the central monitoring station 18. The output devices 44 may include user interface devices, such as display screens, monitors, tactile feedback elements, audio output devices (e.g., speakers), etc. for communicating information to the user.

The communication interface 46 may include wired and/or wireless devices for communicating with one or more of the other components (i.e., the vehicle 12, the diagnostic device 14 and/or the central monitoring station 18). The communication interface 46 may be configured for receiving fault detection data from the vehicle 12 (directly or indirectly) and/or for presenting fault resolution information to the driver and/or other person associated with the vehicle 12.

Vehicle fault data may be extracted from the vehicle 12 and transmitted to the central monitoring station 18 for analysis. The fault data may be transmitted to the central monitoring station 18 through the communication interface 46, which may include a wired connection, a wireless point, or other suitable communication device. Additionally, after the fault data is analyzed by the central monitoring station 18, a problem resolution recommendation may be transmitted from the central monitoring station 18 to the diagnostic device 14 via the communication interface 46 and communication path 20.

The fault group creating module 50 is configured to analyze numerous records of fault information stored in the historical faults database 40. The historical faults database 40 may store millions of records regarding faults that have been detected in any number of vehicles for any number of systems within the vehicles. Using statistical analysis, the fault group creating module 50 is able to group faults that have a high probability of occurring together. Since the fault group creating module 50 uses statistical analysis, and not intuition, to group faults together, there may be associations between components or systems within a vehicle that are more closely related than what an ordinary technician might think. With the faults grouped together, a technician may be able to fix one fault, which may then resolve one or more other faults that might simply be a side effect of the major fault.

Because of the vast amount of information that may be stored in the historical faults database 40, it would be nearly impossible for a technician to analyze the various faults for various engines and vehicles to determine how to group the faults. In the past ten years, for example, there have been four generations of engines that have been introduced in the diesel market, each with various regulations. A skilled technician or mechanic may be able to learn how to group faults for one type of engine over a number of years, but it would be nearly impossible to learn how faults would be grouped for every engine on the market. Of course, since new engines continue to be introduced, the rules will change and the skilled technician will need to learn new behaviors. Because of this ever-expanding fault database, an average technician would not be able to figure out fault groups or troubleshooting orders. Even a skilled technician would not have the time to analyze all the different issues with all the different engines to figure out how the faults might be grouped and to compare and contrast faults to make any sense of it all. Thus, the fault group creating module 50 expedites this process by taking faults detected by many technicians and using statistical analysis to properly group the faults.

Sometimes with trucks, the groupings are not always logical. For example, the statistical data may indicate that an unfixed problem in the engine may cause another problem in the after-treatment system. For example, a fault in a turbo-charger may cause problems in the after-treatment system. Although an ordinary technician may think that a turbo-charger would not be related to the after-treatment system, the statistical data may indicate otherwise. Thus, the grouping of faults and the order of troubleshooting determined by the system can indicate that if fault X is detected, it is likely that fault Y may follow. The system 10 gives access to that information, which may include false resolution that may not be intuitive.

Even after the fault groups are created, an average technician would normally not know which faults to fix first. Many times, the troubleshooting order will not always be intuitive. Although technicians may have knowledge to informally group faults, the vehicle repair guidance system 10 takes the next logical step to group the faults and then analyze each group to determine a proper solution path.

The problem resolution module 52 may be configured to determine troubleshooting orders automatically. In other embodiments, the problem resolution module 52 may be configured to receive input from a number of expert technicians who can create or edit the troubleshooting order according to their skill or knowledge of various engines. The technicians may enter an order based on their knowledge of the causes and effects of various systems within the vehicle. The troubleshooting steps can be entered by the experts using a data entry tool associated with the input devices 42 shown in FIG. 4.

Although the grouping of faults by the fault group creating module 50 may be performed using logical processes of the central monitoring system 18, the troubleshooting order within each group may be determined by computer analysis and human input. The problem resolution module 52 can automatically determine the troubleshooting order to some degree based on pre-programmed rules. In addition, the problem resolution module 52 may present groups of faults to a team of experts with or without the pre-programmed rules in place. From this initial ordering that is performed automatically, the experts can rearrange the order based on knowledge of the vehicles.

Thus, skilled technicians can figure out an order within each group. The problem resolution module 52 can lead the experts through a process for entering the troubleshooting order for each group. Since there have been hundreds of engines introduced in the diesel market from 2004 to the present, the process of manually entering troubleshooting orders may take a long time, especially since the engines may include various sizes, technologies, regulatory levels, etc.

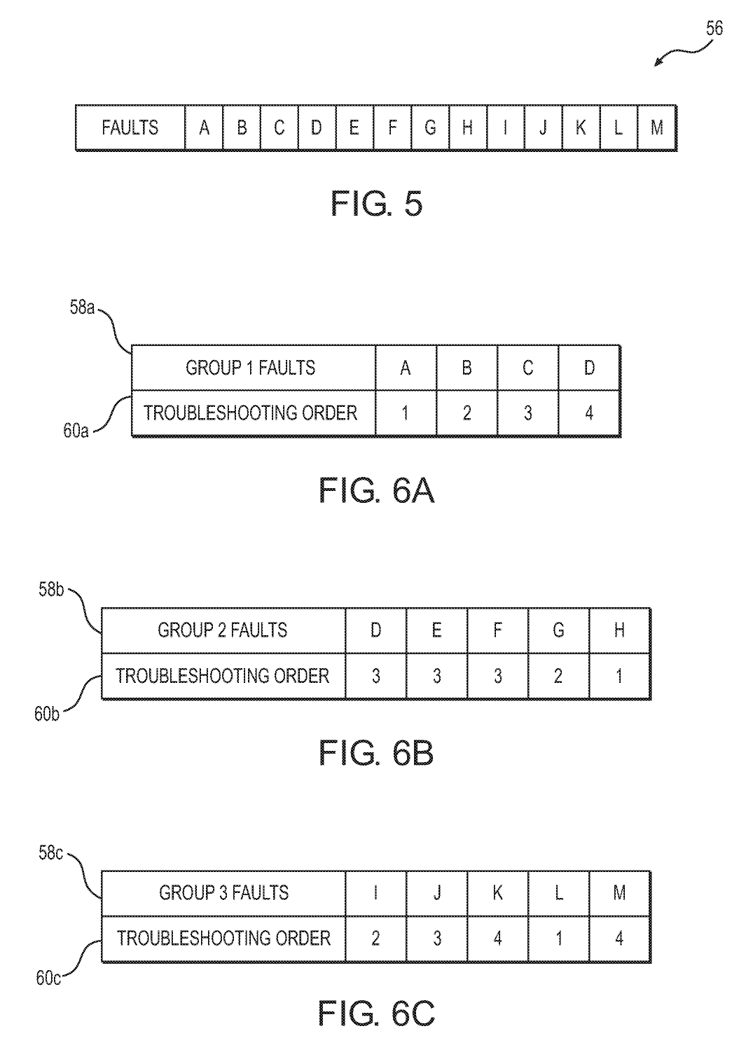

FIG. 5 illustrates an example of a number of faults 56 that may be detected by the central monitoring station 16 and/or a sample of faults that are stored in the historical faults database 40. As shown in FIG. 5, the faults may be labeled simply in alphabetic form for the purpose of clarity and simplicity. Fault data may take the form of characters including but not limited to numbers, letters, and a combination thereof. Each fault may represent any type of defect, inaccuracy, error, component wear, etc. of any component of the vehicle. For example, one fault may represent a detection that brake pads are worn down below a predetermined acceptable thickness.

Upon connecting the diagnostic apparatus to the vehicle 12, the vehicle 12 typically reports multiple faults such that these faults may either be entirely active faults, entirely inactive faults, or a combination thereof. One of the goals of the vehicle repair guidance system 10 and methods thereof, which are based on fault association, may be to simplify the information displayed on the diagnostic apparatus in order to show “groups” of faults that identify the same or similar problems on the vehicle. Another feature is to identify the root cause fault within the identified groups of faults for display on the diagnostic apparatus so that repairs can be scheduled in an order based on the likelihood that a first repair to a root cause fault may resolve lower ordered faults.

The fault data A, B, C, D, E, F, G, H, I, J, K, L, and M, while shown in alphabetical order in FIG. 5, may be in an entirely random order as well. An analyst or operator that examines the received fault data may study each of the individual faults and compare one or more of these faults with pre-identified or pre-ordered fault groups. In other embodiments, the fault group creating module 50 may be configured to automatically process the fault data to determine how faults are to be grouped.

These fault groups may be created from data stored in the historical faults database 40 comprising millions of faults. The creation of fault groups, according to the processes of the fault group creating module 50, may be performed during a pre-analysis process, which results in creating pre-identified or pre-ordered fault groups to be used at a later time. The historical faults in the database 40 may be gathered from any number of vehicles and may be grouped based on make and model of the vehicles. In the pre-analysis process, the historical faults are analyzed in order to determine which faults have a higher likelihood of occurring together on a vehicle. According to some embodiments, the fault group creating module 50 may be configured to assist with associating faults together, based on statistical analysis.

A particular vehicle fault (e.g., fault A) that has a relatively high likelihood of occurring in conjunction with another vehicle fault (e.g., fault B) will be categorized such that fault A and fault B are formed as part of the same group. As such, these groups are made up of faults that are statistically likely to occur together.

FIGS. 6A-6C illustrate tables associating a number of faults into groups and creating a troubleshooting order for resolving the group of faults. It should be noted that some faults may be included in multiple tables since some faults may be detected as being present when various faults are detected. For example, an overheating fault may simply be the result of any number of other core faults that might occur, eventually resulting in the overheating condition.

As part of the pre-analysis process, several additional steps may be taken to reduce the number of redundant and inaccurate fault groupings. For example, fault groups that form subsets of larger groups are removed from the fault group database in order to minimize the number of groups that need to be created and stored. If a fault group comprises faults A and B and another fault group comprises faults A, B, C and D, the fault group that comprises faults A and B may not be created and stored because it forms a subset of a larger fault group, or, alternatively, if the group comprising faults A and B is already created, this group can be eliminated since it is a subset of the bigger group. The actions of reducing fault groupings may be performed automatically by the fault group creating module 50 and/or may allow a user to verify a grouping reduction that may be proposed by the fault group creating module 50 upon detection that fault data collected may be analyzed as possibly being reducible.

Analysts, using the recommendations and analysis of the fault group creating module 50, may then identify certain types of single faults as statistical anomalies because they seem to appear in a variety of different fault groups. These single faults may not necessarily occur in conjunction with a particular set of faults within a fault group, but may simply occur with high frequency any time that there is an occurrence of vehicle faults.

A non-limiting example is the occurrence of a fault indicating a defect associated with a coolant. This defect may appear with a high degree of frequency irrespective of other faults that are detected. As such, it may not be dependent on, or occur based on or in conjunction with a specific set of faults. Thus, the defect associated with a coolant may be eliminated from one or more fault groups. Alternatively, the defect associated with a coolant may be categorized into a group comprising of just the defect associated with the coolant.

After the above two steps are taken, analysts may further study the identified fault groups to identify groups that are not ideal because they do not accurately represent faults that are likely to occur with respect to other faults in the group. As explained above, the fault group creating module 50 may be configured to pre-analyze the fault data and detect these statistical anomalies and then present the anomalies to an expert to determine if the statistical analysis is rooted in sound reasoning regarding fault resolution.

Therefore, in the pre-analysis process, large amounts of historical faults are obtained from multiple repair jobs on multiple vehicles. The fault data may be downloaded from another database or may include an accumulation of fault data received from a number of sources. The faults are then categorized into groups, as shown in FIGS. 6A-6C, based on the likelihood that the faults may also appear together with other related faults. The groups are then simplified or filtered by eliminating redundancies, inaccuracies, or other anomalies. Once the fault groups are completed in the pre-analysis process, these pre-established fault groups can be used to troubleshoot vehicles for other vehicles in the future.

The fault group creating module 50 may be configured to create any number of fault groups for a variety of systems on a vehicle. In some embodiments, the fault group creating module 50 may recommend the fault groups to one or more technical experts and then receive additional information directly from the technical experts to modify the groupings of faults as needed to provide clear and accurate groupings. In some cases, the fault group creating module 50 might present groupings that may initially appear to be unrelated, but upon further diagnosis, may actually be related.

For example, if apparently unrelated faults related to the ignition and steering are grouped together, the fault group creating module 50 may detect a possible design flaw in either or both of the ignition system and steering system that, when a fault is detected in one system, a fault may frequently result in the other system. In this case, the expert may need to perform additional research to determine if these faults should be grouped together. Also, if the expert is part of a design team for designing vehicles, information of faults that overlap from one system to another may be used to improve the system so that the inter-related interference of one system on another can be reduced.

Returning again to the description of FIGS. 6A-6C, the faults that are obtained in a current diagnostic can be used to match with the pre-analyzed fault groups. Analysts then compare the fault data extracted from the vehicle 12 with the fault groups 58a, 58b, 58c to identify overlapping patterns of faults. Each fault within a fault group 58 stored in the historical faults database 40 of the central monitoring station 18 may also include a troubleshooting number associated with it. For example, Group 1 faults 58a comprise faults A, B, C, and D, which have a troubleshooting order 60a comprising troubleshooting numbers of 1, 2, 3, and 4, respectively. Group 2 faults 58b comprise faults D, E, F, G, and H, for example, and have a troubleshooting order 60b with trouble shooting numbers of 3, 3, 3, 2, and 1, respectively. Group 3 faults 58c comprise faults I, J, K, L, and M, for example, and have a troubleshooting order 60c with trouble shooting numbers 2, 3, 4, 1, and 4, respectively.

It should be noted that some faults may appear in more than one fault group. In the example of FIG. 6, the fault “D” is present in faults groups 58a and 58b.

If an analyst finds that the fault data extracted from the vehicle comprises a pattern that matches the faults of Group 2 (i.e., D, E, F, G, and H), then the analyst may recommend beginning the troubleshooting process with fault H, followed by Fault G, and then followed by any one of faults D, E, or F.

Faults that are associated with a troubleshooting number of “1” may be defined as “root cause” faults because it may be determined that this fault resulted in the occurrence of one or more of the other faults within the fault group. For example, fault H in Group 2 (FIG. 6B) represents a root cause fault. Determining the root cause fault may be performed by the processing device 36 again using the fault group creating module 50 shown in FIG. 4. The processing device 36 may utilize historical faults from the database 40 in additional to fault resolution data, which may also be stored in database 40 to determine when the faults within a group are resolved. For example, the fault group creating module 50 may be configured to analyze the historical data in database 40 to determine that the Group 3 faults 58c in FIG. 6C were resolved after the fault L was resolved, or that the Group 3 faults 58C in FIG. 6C were resolved after faults L and I were resolved.

It is likely that resolution of the root cause fault might result in the resolution of the remaining faults in the fault group. As such, troubleshooting vehicle faults by identifying and resolving the root cause faults will likely result in a speedy and efficient resolution of multiple faults extracted from the vehicle 12. If the other faults are not resolved by the troubleshooting of the root cause fault, a mechanic may go on to fix the next fault in the ordered list in an attempt to resolve the remaining faults.

FIGS. 6A-6C show examples of root cause faults identified with the troubleshooting order number “1” in the various fault groups. Each of the root cause faults identified form the basis of problem resolution recommendation. For example, in Group 1, fault A is identified as the root cause fault for this group of faults including A, B, C, and D. In Group 2, fault H is identified as the root cause fault; and in group 3, fault L is identified as the root cause fault. According to one example, if faults A, B, and C were detected in a vehicle, the problem resolution recommendation or troubleshooting order would include a recommendation of troubleshooting fault A first, then fault B, and then fault C. In some situations, resolving fault A may consequently resolve faults B and C, since fault A is the root cause fault and may be the reason why faults B and C were also detected. Based on the pre-analysis of grouping faults and determining a root cause fault in each group by execution of the fault group creating module 50, a troubleshooting order can be provided to the diagnostic apparatus for resolving the faults.

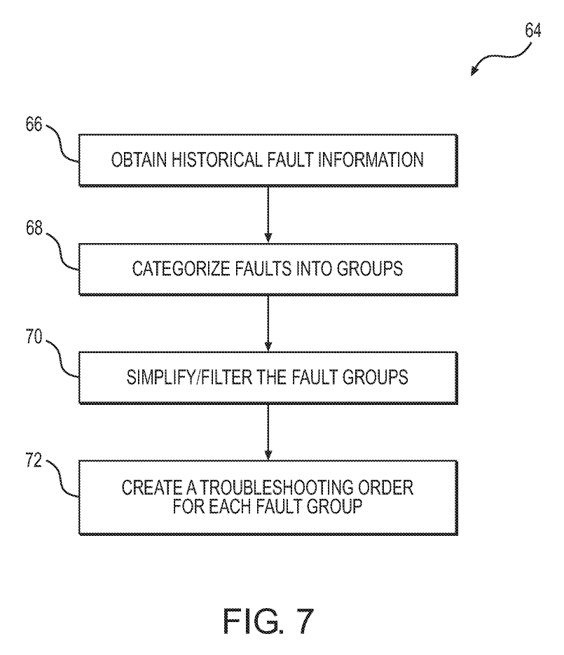

FIG. 7 is a flow diagram showing a method 64 for creating fault groups as described above. The method 64 of FIG. 7 may represent a pre-analysis process, the results of which may be used at a later time when diagnostic processes are performed for a vehicle. In this embodiment, the method 64 includes a first step of obtaining a multiplicity of historical fault information, as indicated in block 66. The historical fault information may be obtained from any number of sources and may be related to a number of diagnostics tests and repair information for any number of vehicles over any length of time. In some embodiments, expert technicians may provide troubleshooting information and root cause information.

In some embodiments, the fault group creating module 50 may be configured to create associations of certain types of faults with other external factors. For example, vehicles driven in cooler climates may include a greater likelihood of developing faults associated with salted roads than those vehicles driven in more moderate climates. Another example may include determining that certain faults may have a higher likelihood of occurring as a vehicle gets older.

Returning to FIG. 7, the method 64 further includes the step of categorizing the multiplicity of historical faults into groups, as indicated in block 68. The process of categorizing faults into groups may be based on statistical analysis that determines the faults that have a higher chance or likelihood of occurring or appearing together. Certain faults may occur at a much greater frequency when another fault (e.g., a root fault) occurs. An association algorithm may be used by the processing device 36 for choosing groups by identifying the faults that tend to occur together. The group of faults may include faults that are in the same category or are the same or similar faults.

According to some situations, certain types of faults may be determined to be independent of other faults. In these situations, the fault group creating module 50 may be configured to put a fault, which is determined to include no significant correlation with other faults, into a new group or into a group all by itself.

The method 64 further includes, according to some embodiments, the step of simplifying or filtering the fault groups, as indicated in block 70. The process of simplifying/filtering groups may include removing faults that appear in multiple groups and seem to simply result with the occurrence of other faults. Some groups may be eliminated if they are simply subsets of a group that includes a greater number of related faults. Some simplification may include the result of the fault group creating module 50 inquiring with an expert or group of experts to receive useful feedback that may not be recognizable from data analysis.

After statistical analysis is done to categorize faults, the fault groups can be imported into the database 40. After this, the fault groups are validated by experts to confirm that the groups are logical. The expert can observe the faults groups on the computer and make sure that the groupings make sense and are not some statistical anomaly. The software can also store a set of rules that can be used to validate the fault groups. A software program of the fault group creating module 50 may be used to check if the fault groups pass all conditions to be marked as valid. If necessary, it can mark a group as “needs manual review,” which acts as a flag that a technician or specialist can see for follow-up actions.

Once the fault groups are validated, a priority system is used to determine the priority of faults based on fault codes or look-up codes, a failure mode indicator (FMI), and the relative location of components on a vehicle.

The validation process enables the technician or specialist to view the fault groups and work through each fault group to determine a proper troubleshooting order. The problem resolution module 52 can be configured with rules for prioritization, which makes it possible for the specialist to create rules for organizing the faults in a logical order. Once the rules are in place, the software can enable the technician to check the different vehicles from each fault code from each group against those conditions. Thus, it can output correct priorities as valid and invalid groups. The problem resolution module 52 may allow the computer to perform this validation process automatically.

During validation, there may be a situation where the group does not fall within one of the set conditions. Most of the time, the statistical analysis is correct, but occasionally there may be anomalies. There will be a final manual review if a group does not validate correctly.

The simplification step 70 may include eliminating redundant groups, eliminating small groups that are already included in larger groups, removing faults that may appear in multiple groups, and other simplifying processes. When the faults are grouped in a simplified form, the method 64 further includes the step, as indicated in block 72, of creating an order in which a technician may troubleshoot the faults, starting with a root cause fault (or most significant fault) and subsequent faults.

After pre-analysis is performed according to the method 64 of FIG. 7 for one or more vehicles, the fault groups can be utilized to provide vehicle repair guidance when repairs are needed at a later time.

In some embodiments, the fault groups and/or simplified/filtered fault groups can be presented to one or more expert technicians or mechanics. For example, the fault group creating module 50 can present the groups to the experts in a GUI on a display device. The fault group creating module 50 enables the experts to review the groups and remove any anomalies that are discovered. The experts may also alter/eliminate groups based on their expertise in the field of mechanics.

The step of creating a troubleshooting order for each fault group, as indicated in block 72, according to some embodiments, may involve a troubleshooting order based on known troubleshooting orders that are stored in the database 40 and/or based on data that the fault group creating module 50 can utilize to determine which troubleshooting order resulted in the most efficient resolution.

Regarding the step of creating the troubleshooting order described in block 72, the central monitoring station 18 may be configured to use pre-established rules as well as user input to create a troubleshooting order for each fault group. The input devices 42 may be used to receive information from an expert technician for establishing the troubleshooting order. This information can be entered manually. The problem resolution module 52 may be configured to take the information that is entered manually and store the troubleshooting order for future use. Also, the problem resolution module 52 may be configured to establish rules for ordering the faults for other fault groups based on commonly entered patterns.

Therefore, the processing device 36 can utilize the fault group creating module 50 to categorize faults and form fault groups and a troubleshooting order for each fault, as described with respect to FIG. 7. After this pre-analysis method 64 is completed, the processing device 36 may then utilize the problem resolution module 52 to troubleshoot and resolve faults as they are detected.

The method of FIG. 7 can be accomplished to establish a set of fault groups and corresponding problem resolution orders for an up-to-date basis. The software with this information can then be distributed to technicians for use on individual diagnostic devices 14. In some embodiments, the diagnostic devices 14 may be configured to access a website that is supported by the central monitoring station 18. Thus, by keeping the fault groups and resolution order up-to-date on the central monitoring station 18, the diagnostic device 14 can use the latest version of the software. In other embodiments, the diagnostic device 14 may occasionally download the needed information from the central monitoring station 18 to store up-to-date information or, alternatively, the central monitoring station 18 can push updates to the diagnostic devices 14.

Rules regarding grouping and troubleshooting can be updated, such that when a client wishes to purchase the vehicle diagnostic software, the software with the updated rules can be sent as part of a package. Data can be stored on a server, such as on the central monitoring station 18, which can then be accessed from the server through the Internet.

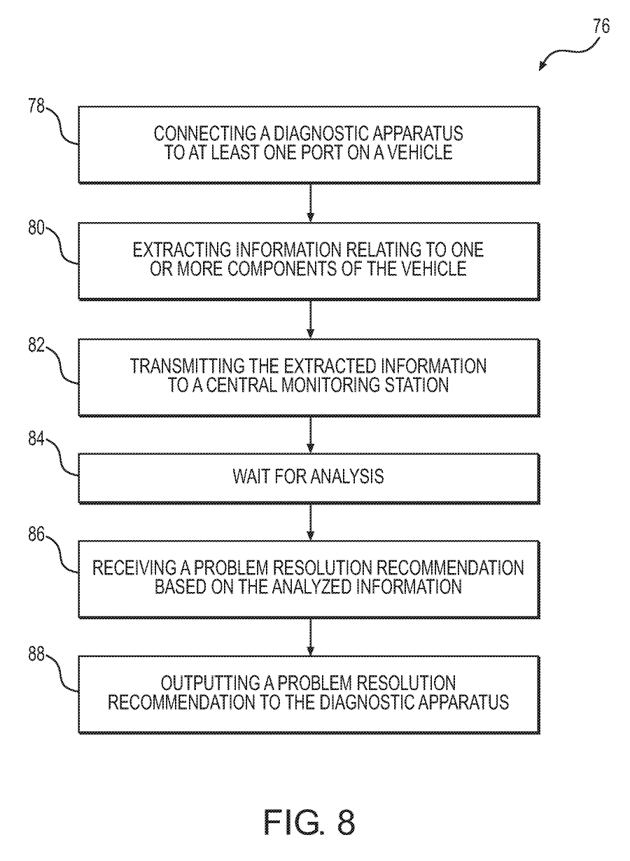

FIG. 8 is a flow diagram showing a method 76 for providing vehicle repair guidance. The method 76 may be performed after pre-analysis methods associated with the fault group creating module 50 have been completed, such as the processes described with respect to the method 64 of FIG. 7.

As shown in FIG. 8, the method 76 includes a first step of connecting a diagnostic apparatus to at least one port on a vehicle, as indicated in block 78. For example, the diagnostic apparatus may include the diagnostic device 14, central monitoring station 18, and/or communication devices (e.g., cable 16, communication path 20, etc.) shown in FIG. 1.

The method 76 is configured to extract fault information relating to one or more components of the vehicle, as indicated in block 80. For example, the vehicle 12 may be configured to transmit fault data from a port of the vehicle 12 to the diagnostic device 14. The method 76 also includes transmitting the extracted information, via a wired or wireless communication medium, to a central monitoring station (e.g., central monitoring station 18), as indicated in block 82.

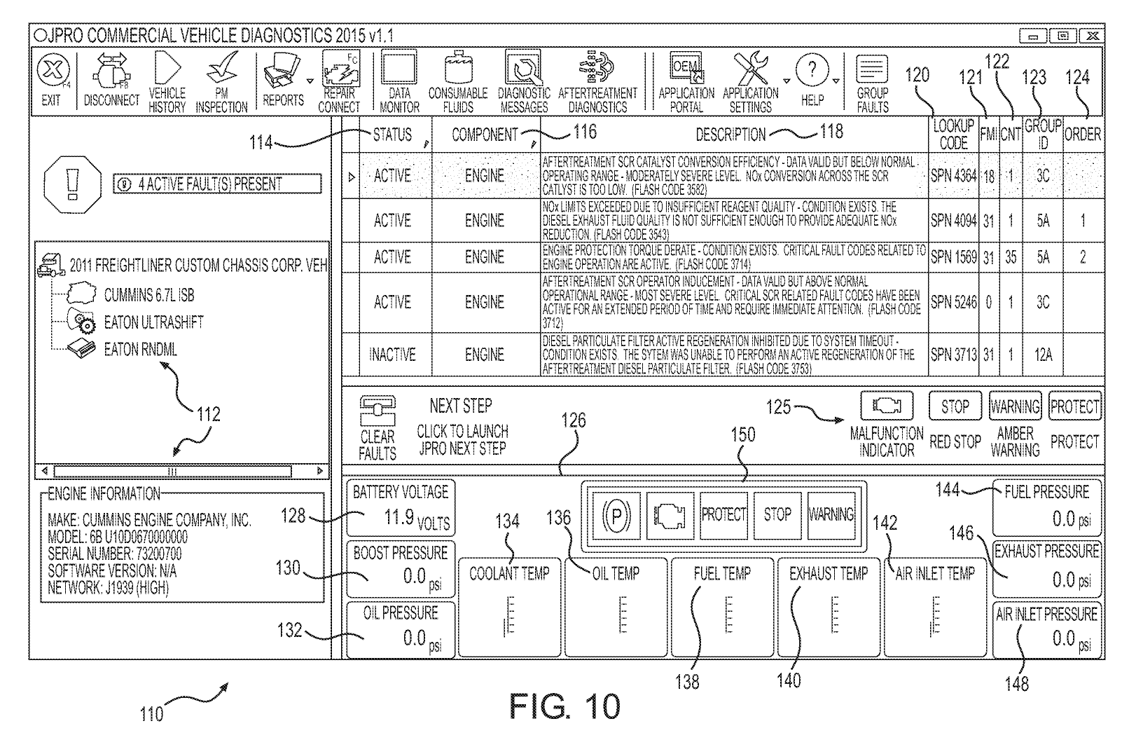

At the central monitoring station 18, the fault information that is extracted from the vehicle is analyzed to determine a problem resolution recommendation. The problem resolution recommendation may include an order of troubleshooting steps that may be taken to troubleshoot the vehicle. In method 76, the diagnostic apparatus may be configured to wait for an analysis, as indicated in block 84, or the user may wait for the diagnostic apparatus itself to perform the analysis. According to block 86, the diagnostic apparatus receives the problem resolution recommendation, based on the analyzed information. The problem resolution recommendation received by the diagnostic apparatus from the central monitoring station or determined on its own (if so equipped) may then be output to a user. For example, the diagnostic apparatus may include a display screen or other display device for outputting the problem resolution recommendation, which may include information as shown in FIG. 10.

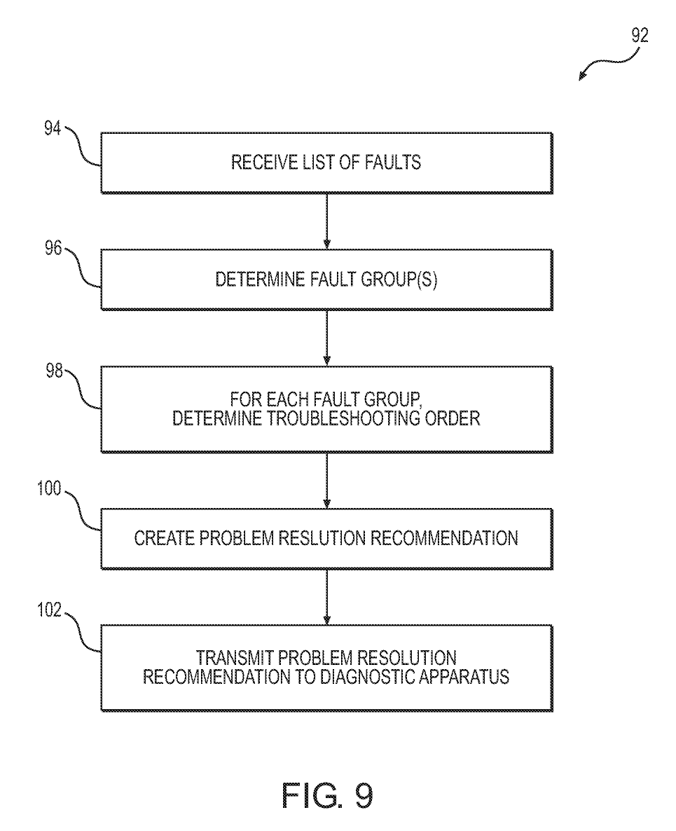

The method 76 of FIG. 8 is associated with the use of the diagnostic apparatus, which includes parts of the vehicle repair guidance system 10. When faults are detected, they may be sent to the central monitoring station 18 for processing. At that time, the central monitoring station 18 returns a problem resolution recommendation (as described in block 86 and 88 of the method 76 of FIG. 8) or the diagnostic apparatus, if it is so equipped, determines the problem resolution recommendation. The process of utilizing the fault groupings to determine the problem resolution recommendation is described below with respect to FIG. 9. A pre-analysis method, which may take place before the method of FIG. 9, may be included, such as the pre-analysis method 64 of FIG. 7.

FIG. 9 is a flow diagram illustrating a method 92 that may be conducted by the central monitoring station 18 during a troubleshooting operation. In other embodiments, the diagnostic apparatus (e.g., diagnostic device 14) may have the capabilities to utilize historical fault data for creating a problem resolution recommendation. As indicated in block 94, the central monitoring station 18 receives a list of faults that are detected. The receipt of information regarding the detected faults may be associated with step 82 of method 76 of FIG. 8 in which the extracted information relating to one or more components and/or faults are transmitted to the central monitoring station.

Upon receiving the list of faults, the method 92 further includes the step of determining one or more fault groups, as indicated in block 96. The fault groups may represent groups such as the exemplary groups shown in FIGS. 6A-6C and may include two or more faults that represent each group. The faults are compared with the fault groups to determine which fault groups most closely match the faults. In some embodiments, the faults that are extracted from the vehicle may include fewer than all the faults in a particular fault group.

For each fault group, the method 92 includes determining a troubleshooting order, as indicated in block 98. For example, using the troubleshooting order 60b shown in FIG. 6B, the troubleshooting order includes analyzing the fault H first, then G, then any one or all of faults D, E, and F. According to block 100, the method 92 includes creating a problem resolution recommendation for each fault group based on the troubleshooting order and detected faults in the fault groups.

For example, the problem resolution recommendation includes recommending an order of first troubleshooting the root fault of each group and then troubleshooting additional faults in sequence, based on the troubleshooting order, as needed, until the issues are resolved. Therefore, the recommendation may include analyzing certain components for faults until all the faults are resolved. The problems may be resolved quickly, such as if the root fault is the cause of all the faults in the group, or may be resolved after further analysis, such as if a component fault lower in the order is detected as being defective and the resolution of that fault as resolves the even lower faults.

In the situation where the extracted faults make up only a portion of the entire number of faults in a fault group, the troubleshooting order may only include those faults that were detected in the vehicle. Otherwise, the troubleshooting order may include a sequence of troubleshooting steps for components or issues that were not detected. Using only a subset of a fault group, the detected faults can be ordered according to the troubleshooting order or sequence 60, while simply ignoring the faults in the respective group that are not included in the list of detected faults.

Once the problem resolution recommendation is created, the method 92 includes transmitting the problem resolution recommendation from the central monitoring station 18 back to the diagnostic apparatus (e.g., to the diagnostic device 14), as indicated in block 102. This step 102 may correspond to block 86 of the method 76 of FIG. 8, which indicates that the problem resolution recommendation is received.

As a result of the systems and methods for creating fault groups and determining a troubleshooting order, the acquired strategy for maintenance can be shared with technicians wherever the vehicle repair guidance system 10 is in use. Therefore, the systems of the present disclosure can help technicians that are not necessarily highly skilled. With the knowledge and expertise being shared, the technicians will have access to guidance that can improve the technicians' skill levels. The technicians may improve their skills because they will have access to accurate information that will point to a correct solution to a problem.

FIG. 10 is a schematic diagram illustrating an embodiment of a graphical user interface (GUI) 110 that displays details of fault data detected in a vehicle. On the left side of the GUI 110, a vehicle description 112 is provided. In some embodiments, the vehicle description 112 may include details regarding the engine and other systems/components of the vehicle.

The GUI 110 may also include a table showing one or more faults. The table may include a status column 114, a component column 116, a description column 118, a lookup code column 120, a failure mode indication (FMI) column 121, a count (“CNT”) column 122, a group ID column 123, and an order column 124.

The status column 114 is configured to indicate the type of fault that is received from the vehicle. The type of fault in the status column 114 may be one of an active, inactive, pending, or permanent fault. An active fault is one that may have physical manifestations on the vehicle's performance. For example, an active fault may be identified as the power of the engine may be cut such that the vehicle is sluggish, or the vehicle may emit white or black smoke, or other similar issues. These are the types of faults that should normally be fixed as soon as possible because they will have a great impact on the vehicle's performance.

Inactive faults may be certain types of faults that might not have a great impact on performance, but may represent a fault that was active at an earlier time. In some cases, an inactive fault may be a fault that is intermittent and has gone from active to inactive or vice versa several times. In the exemplary view in FIG. 10, the count number 122 shows that the fault with lookup code SPN 1569 has a count of “35,” which indicates that the fault has switched between active and inactive 35 times.

In some situations, inactive faults may be electrical faults, such as a short circuit, which may be temporary. If it's no longer active, the status 114 will switch to inactive. If the number of inactive faults is high, it may be an indication that there is a problem that needs to be resolved.

The component column 116 is configured to indicate which component or system within the vehicle contains a fault. In the example of FIG. 10, only faults related to the engine are shown. Other system components may include electrical, braking, steering, etc.

The GUI 110 also includes the description column 118, which includes a description of the fault. The description column 118 may also include a flash code associated with each description.

Also, a lookup code 120 includes a code that is associated with the particular fault. The lookup code 120 allows a user to look up a fault in an online manual or other electronic service. The code can be used as a search term on an electronic service (e.g., Cummins ISB manual), which may be published online by the OEMs.

The GUI 110 also includes the failure mode indicator (FMI) 121, which provides an indication of how the failure is occurring. The FMI 121 provides a number (e.g., 0-31), where some codes are related to data, others are related to electrical, others are related to plausibility, and still others indicate an unknown failure.

The Count (“CNT”) column 122 provides a count of the number of times a fault has switched to active, either from a non-existent condition or from an inactive state. The count of “35” in the one example indicates that the fault has gone to active and then switched to inactive and back to active 35 times, which could be an indication that the problem has not been dealt with over a long period of time. This count can indicate if there is an intermittent problem or a constant problem and gives an indication of how frequently the fault comes up.

The next column is the Group ID column 123, which identifies faults within groups. For example, when a number of faults are detected, they may be listed all together, regardless of whether they are related. When the user selects the “GROUP FAULTS” button on the top ribbon of the GUI 110, the fault group creating module 50 groups the faults according to the predetermined fault groups. The table within the GUI 110 may be displayed such that only one fault group at a time is shown and the other faults within other fault groups are minimized. The user may be able to expand or collapse fault groups as needed. For example, if the user selects the faults within a group identified in the Group ID 123 as “5A,” then only the second and third faults in this example will be shown in the expanded view, whereas the other faults will be in a collapsed view.

Again, if the faults in group “5A” are selected, the next column (i.e., Order column 124) shows the predetermined troubleshooting order of that group. In the illustrated example, the fault having lookup code SPN 4094 is given a number “1” to indicate that this is likely a root fault and should be fixed first. In many cases, the resolution of this first fault may result in the other faults within that group being fixed as well. In this same example, the fault having lookup code SPN 1569 is given a number “2” to indicate that this is the second fault in the troubleshooting order. As suggested above with respect to FIGS. 6A-6C, any number of faults may be included in each fault group; also, the troubleshooting order may include some faults with the same order number to indicate that those faults may be fixed in any order desired.

Below the table, a “CLEAR FAULTS” button is available. This button can be selected to attempt to clear out inactive faults permanently or to try to get an active fault to go away to see if it comes back again. For example, it is common in diagnostics to try to force the fault to go away by retesting and looking to see if it comes back.

The four indicators 125 are lamps that correspond to the same lamps that may be displayed on the dashboard of a vehicle being tested. The lamps 125 emulate what the driver may see on the dashboard. The lamps 125 include a malfunction indicator, red stop, amber warning, and protect, which may indicate the severity of faults, ranging from an emission issue to a fault that should be handled immediately.

The key data points indicators 150 also include some of the same indicators 125, with the addition of an indication “P” that the vehicle is in “park.” The key data points indicators 150 indicate the total state of all the faults and include information that a technician would need to diagnose the vehicle, showing the “engine,” “transmission,” and “brake” key data points.

In addition to indicating faults, the GUI 110 may also include a section 126 where additional information is shown. For example, the section 126 may include a battery voltage indicator 128, a boost pressure indicator 130, an oil pressure indicator 132, a coolant temperature indicator 134, an oil temperature indicator 136, a fuel temperature indicator 138, an exhaust temperature indicator 140, an air inlet temperature indicator 142, a fuel pressure indicator 144, an exhaust pressure indicator 146, and an air inlet pressure indicator 148. The section 126 may further include the key data point indicators 150, which may be warning signals for indicating various conditions.

The GUI 110 of FIG. 10 may further include a “Group Faults” button. By pressing the group faults button, the user instructs the system to group the faults that have been detected according to the groupings already determined by the fault group creating module 50. The detected fault may include faults that appear in one or more groups. The GUI 110 can then allow the user to select a group to be displayed in the table. The problem resolution module 52 is configured to indicate to the user the troubleshooting order of the detected faults. For example, if only two faults from one group are detected, the GUI 110 may indicate (based on the troubleshooting order described with respect to FIG. 6) which of the two faults should be fixed first. As a result of fixing the first fault, the second fault may be resolved as well.

For example, assuming that the two faults having lookup codes SPN 4094 and SPN 1569 are detected and are determined to be handled within the same group, and assuming that SPN 1569 is merely a side effect of the other fault, the GUI 110 will indicate the order that the faults should be fixed. The group ID 123 identifies the group that the fault belongs in. The order is the troubleshooting order in which the faults should be fixed. In this example, the order of only two of the faults, which belong to the group ID of “5A,” are shown, where the SPN 4094 is recommended as being fixed first and the SPN 1569 would be fixed next if fixing SPN 4094 does not already resolve the SPN 1569 fault. Even if the SPN 1569 fault is not fixed for a long time, the vehicle may be configured to automatic shut down or provide limited performance until the fault is fixed.

The systems described above may be used for inspecting trucks. Although automobiles must go through a yearly inspection process to maintain registration of the vehicle, trucks do not have the same requirements. Therefore, it is up to the truck owner to have problems fixed as needed. Trucks can be equipped such that if a problem is not fixed for a long time, it may be configured to react in a way to force the owner to fix the problem, such as by limiting the top speed of the vehicle.

Instead of or in addition to the order number in the Order column 124, the fault order may be listed in order of importance from top to bottom, or in any other suitable manner.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied.

Any combination of one or more non-transitory computer-readable media may be utilized. The non-transitory computer-readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of the computer readable storage medium may include: an electrical connection having one or more wires, a portable computer diskette, a hard disk, a random access memory (RAM), a read-only memory (ROM), an erasable programmable read-only memory (EPROM or Flash memory), an electrically erasable programmable read-only memory (EEPROM), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a 4 carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “c” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The flowcharts and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The flowcharts and block diagrams in the figures illustrate the architecture, functionality, and operation of possible implementations of systems, methods, and non-transitory computer-readable media programs according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to embodiments of the invention in the form disclosed. Many modifications and variations will be apparent to those of ordinary skill in the art without departing from the scope and spirit of embodiments of the invention. The embodiment was chosen and described in order to best explain the principles of embodiments of the invention and the practical application, and to enable others of ordinary skill in the art to understand embodiments of the invention for various modifications as are suited to the particular use contemplated.

Although specific embodiments have been illustrated and described herein, those of ordinary skill in the art appreciate that any arrangement which is calculated to achieve the same purpose may be substituted for the specific embodiments shown and that embodiments of the invention have other applications in other environments. This application is intended to cover any adaptations or variations of the present invention. The following claims are in no way intended to limit the scope of embodiments of the invention to the specific embodiments described herein.

1. A method comprising the steps of:
obtaining historical data related to a plurality of vehicle component faults that have been detected in a plurality of vehicles having a plurality of makes and models;
storing the historical data in a computer database;
statistically associating the vehicle component faults to categorize the vehicle component faults into a plurality of fault groups, such that the vehicle component faults that are categorized in the same fault group have a higher probability of occurring together than vehicle component faults that are categorized in different fault groups;
identifying and eliminating fault groups that are mathematical subsets of larger fault groups;
identifying and eliminating vehicle component faults that appear in multiple fault groups;
creating a troubleshooting order for each fault group, each troubleshooting order including a sequence of troubleshooting steps for resolving the vehicle component faults in the respective fault group, the troubleshooting order to be used when a vehicle to be diagnosed includes multiple vehicle component faults in a respective fault group; and
storing the fault groups and corresponding troubleshooting order in the computer database.

2. The method of claim 1, further comprising the steps of:
presenting the fault groups to one or more expert technicians; and
enabling the one or more expert technicians to adjust the sequence of troubleshooting steps in at least one of the fault groups.

3. The method of claim 1, further comprising the steps of:
receiving a list of faults that are detected in a vehicle being serviced;
identify one or more pre-defined fault groups in which the list of faults can be categorized; and
creating a problem resolution recommendation based on the list of faults and the corresponding sequence of troubleshooting steps for each of the pre-defined fault groups.

4. The method of claim 3, further comprising the steps of:
transmitting the problem resolution recommendation to a diagnostic apparatus; and
displaying the problem resolution recommendation on a display device of the diagnostic apparatus to enable a technician to resolve the faults according to the sequence of troubleshooting steps.

5. A method comprising the steps of:
obtaining historical data related to a plurality of vehicle component faults detected from a plurality of vehicles; and
statistically associating the vehicle component faults to categorize the vehicle component faults into a plurality of fault groups such that the vehicle component faults that are categorized in the same group have a higher probability of occurring together than vehicle component faults that are categorized in different groups.

6. The method of claim 5, further comprising the step of creating a troubleshooting order for each fault group, each troubleshooting order including a sequence of troubleshooting steps for resolving the vehicle component faults in the respective fault group.

7. The method of claim 6, further comprising the steps of:
presenting the fault groups to one or more expert technicians; and
enabling the one or more expert technicians to adjust the sequence of troubleshooting steps in at least one of the fault groups.

8. The method of claim 5, further comprising the step of using an algorithm to statistically associate the vehicle component faults.

9. The method of claim 5, wherein the historical data includes make and model information.

10. The method of claim 9, wherein the step of statistically associating the vehicle component faults further includes at least partially associating the vehicle component faults based on the make and model information.

11. The method of claim 5, further comprising the step of identifying and eliminating fault groups that are mathematical subsets of a larger fault group.

12. The method of claim 5, further comprising the step of identifying and eliminating vehicle component faults that appear in multiple fault groups.

13. A system comprising:
a diagnostic apparatus arranged in electrical communication with a port of a vehicle to be serviced, the diagnostic apparatus configured to extract fault data via the port, the fault data including a list of vehicle component faults detected by a plurality of electronic control units (ECUs) integrated in the vehicle; and
a central monitoring station arranged in electrical communication with the diagnostic apparatus to obtain the list of vehicle component faults;
wherein the central monitoring station is configured to identify one or more pre-defined fault groups in which the list of vehicle component faults can be categorized; and
wherein the central monitoring station is further configured to create a problem resolution recommendation based on the list of vehicle component faults and a pre-established troubleshooting order for each of the pre-defined fault groups.

14. The system of claim 13, wherein the central monitoring station is further configured to transmit the problem resolution recommendation to the diagnostic apparatus for displaying the problem resolution recommendation on a display device of the diagnostic apparatus to enable a technician to resolve the faults according to the pre-established troubleshooting order.

15. The system of claim 13, wherein the central monitoring station comprises a historical fault database configured to store the one or more pre-defined fault groups categorizing the vehicle component faults.

16. The system of claim 15, wherein the central monitoring station further comprises a fault group creating module configured to categorize the vehicle component faults into the pre-defined fault groups such that vehicle component faults that are categorized in the same pre-defined fault group have a higher likelihood of occurring together than vehicle component faults that are categorized in different pre-defined fault groups.

17. The system of claim 16, wherein the fault group creating module is further configured to create the troubleshooting order for each of the fault groups, each troubleshooting order including a sequence of troubleshooting steps for resolving the vehicle component faults in the respective fault group.

18. The system of claim 16, wherein the fault group creating module is further configured to present the pre-defined fault groups to one or more expert technicians and enable the one or more expert technicians to adjust the sequence of troubleshooting steps in at least one of the pre-defined fault groups.
